(19) United States
(12) Patent Application Publication
(10) Pub. No.: US 2015/0271126 A1
(43) Pub. Date: Sep. 24, 2015

(54) EVENT CREATION AND ORGANIZATION

(71) Applicant: Drgnfly, Inc., San Francisco, CA (US)

(72) Inventors: Barthelemy Menayas, San Francisco, CA (US); Benjamin Thompson, Oakland, CA (US)

(21) Appl. No.: 14/220,895

(22) Filed: Mar. 20, 2014

(51) Int. Cl. H04L 12/58; H04L 29/08

(52) U.S. Cl. CPC H04L 51/32; H04L 67/18; G06Q 50/01

(57) ABSTRACT

Improved techniques for scheduling and organizing events and/or meetings. An example includes use of improved location tracking techniques, which can employ geofencing. Another example includes an improved schedule that is clearly organized and easy to interpret. Another example includes improved methods for suggesting potential participants for an event.

### TECHNICAL FIELD

The present disclosure relates generally to the fields of location tracking and social networks, and in particular to improved techniques for using geofences, which in some cases can assist in the scheduling of events.

### BACKGROUND

For a variety of reasons, it can be useful to determine and/or monitor the location of individuals and/or objects. One technique for tracking location is through use of global positioning system (GPS) technology. This technique involves the continuous receipt by a GPS antenna of time-stamped signals sent by satellites located in outer space. Location can then be determined based on the time it takes the signals to arrive. Another technique is the use of geofences, which is a virtual parameter that can be designed in a desired size or shape by an administrator. In example situations, as geofence enabled devices cross the threshold of a geofence boundary they send a notification to the administrator.

### SUMMARY

In general, one aspect of the subject matter described in this specification can be embodied in methods that include the actions of identifying an activation point, the activation point being a geographic location where an application on a client device was activated; establishing a first geofence having a respective geographic area that encompasses the activation point; identifying a plurality of second geofences each second geofence having a respective geographic area; determining a respective score for each of the second geofences wherein the score is based on, at least, a number of previous activations of the application on the client device when the client device was located in the geographic area of the second geofence; selecting one or more of the second geofences based on the respective scores and removing the selected second geofences; and determining an approximate location of the client device based on a smallest respective geographic area of an existing geofence that encompasses a current location of the client device. Other embodiments of this aspect include corresponding systems, apparatus, and computer programs.

These and other aspects can optionally include one or more of the following features. In some instances, the geographic area of the first geofence can overlap with each of the respective geographic areas of the one or more removed second geofences. In such instances, the respective areas of the first and second geofences can be of the same size. Further, in such instances, determining a respective score for the first geofence can be based on the respective score of the removed second geofence having a highest respective score. The geographic area of a particular second geofence can encompass the geographic area of the first geofence or one of the second geofences. A respective score for a particular second geofence can include a weighted combination of previous activations. In such cases, a respective weight of a particular previous activation can be based on an age of the particular previous activation. In some instances, only one previous activation per time period counts towards the score. The application can be activated by a user when the application is initially executed or brought into a foreground execution mode. A particular geofence can be a polygon, a circle, or an ellipsoid. A third geofence can be established having a respective geographic area that encompasses the respective geographic area of the first geofence. A determination can be made of whether a period of time has passed since a subsequent activation of the application on the client device has occurred in the first geofence, and based on that determination, the first geofence can be removed.

In general, one aspect of the subject matter described in this specification can be embodied in methods that include the actions of ordering a plurality of unviewed items according to a first order wherein each unviewed item has a respective date; ordering a plurality of viewed items according to a second order wherein each viewed item has a respective date that is the same as a current date; ordering a plurality of upcoming items according to a third order wherein each upcoming item has a respective date that follows the current date; presenting a view of a list of items in a graphical user interface (“GUI”) wherein the list of items comprises a concatenation of the ordered unviewed items, the ordered viewed items and the ordered upcoming items; receiving a new item and adding the new item to the ordered plurality of unviewed items according to the first order, wherein the new item is not visible in the view; after receiving the new item, presenting a visual indicator in the graphical user interface indicating that there is a new item; receiving user selection of the visual indicator, and based on the user selection: scrolling the list of items in the view until the new item is visible in the view; after scrolling, changing an appearance of the new item and of the indicator in the graphical user interface to indicate that the new item has been viewed; and removing the new item from the plurality of unviewed items. Other embodiments of this aspect include corresponding systems, apparatus, and computer programs.

These and other aspects can optionally include one or more of the following features. A particular unviewed item can be a message with its respective date being its date of receipt, or a particular unviewed item can be an event with its respective date being the date on which the event takes place. A particular viewed item can be a previously viewed message received on a current date or can be a previously viewed event associated with the current date. A particular upcoming item can be an event having a respective date that follows the current date. The new item can be generated by a client device associated with a first user. A particular event can be associated with a respective location. The indicator can present a number in the graphical user interface and changing the appearance of the indicator can comprise decrementing the number. In other instances, changing the appearance of the indicator can comprise removing the indicator from the graphical user interface. The first order can be according to the respective dates. In such instances, items having more recent dates can occur in the order before items having less recent dates. The new item can be a message, and can be added to the plurality of viewed items according to the second order. The new item can be an event, and, based on its respective date, can be added to the plurality of viewed items according to the second order or to the plurality of upcoming items according to the third order. The new item can occur in the list above or below the view. The visual indicator can be positioned at an upper or lower edge of the view. User input can be received scrolling the list of items in the view until a second new item containing new content is visible in the view; and an appearance of the second new item can be changed to indicate that the second new item has been viewed.

In general, one aspect of the subject matter disclosed in this specification can be embodied in methods that include the actions of receiving acceptance from one or more first individuals and one or more second individuals of an invitation to attend an event scheduled using a first social network where the one or more first individuals are members of the first social network and the one or more second individuals are not members of the first social network; selecting one or more of the second individuals based on a first set of criteria; and suggesting the selected one or more second individuals to a member of the first social network as potential participants for future events. Other embodiments of this aspect include corresponding systems, apparatus, and computer programs.

These and other aspects can optionally include one or more of the following features. The first set of criteria can require that the member of the first social network has accepted and/or received an invitation to attend the event to which the one or more second individuals were invited. The first set of criteria can require that the member of the first social network has a degree of social indirection with an individual that received an invitation to attend the event to which the one or more second individuals were invited. One or more of the second individuals can be members of a second social network, and an invitation can be sent to one or more of the second individuals through the second social network. An invitation can be sent to one or more of the second individuals through Short Message Service (“SMS”) messaging or email. One or more of the first individuals can be selected based on a second set of criteria, and such selected individuals can be suggested to the member of the first social network as potential participants for future events. The second set of criteria can require that the member of the first social network has accepted and/or received an invitation to attend the event to which the one or more first individuals were invited. The second set of criteria can require that the member of the first social network has a degree of social indirection with an individual that received an invitation to attend the event to which the one or more first individuals were invited. One or more third individuals can be suggested to the member of the first social network as potential participants for future events, where the one or more third individuals are located within a predetermined geographic distance of the member. The location of a particular third individual can be determined based on geographic location information obtained from the first social network. One or more fourth individuals can be suggested to the member of the first social network as potential participants for future events, where the one or more fourth individuals has interacted with the member within a preceding predetermined period of time. The member of the first social network and the one or more fourth individuals can have interacted via at least one of the first social network, a social network that is different than the first social network, SMS messaging, and email. A view of graphical representations of potential participants for future events can be presented in a graphical user interface, where the view comprises a concatenation of graphical representations of the first individuals, the second individuals, the third individuals, and the fourth individuals.

In general, one aspect of the subject matter described in this specification can be embodied in methods that include the actions of receiving user selection of one or more individuals to invite to an event; receiving additional user input regarding the event; and sending invitations to the one or more selected individuals, where the steps of receiving additional user input and sending invitations, combined, comprise no more than three user interactions with a client device. Other embodiments of this aspect include corresponding systems, apparatus, and computer programs.

These and other aspects can optionally include one or more of the following features. The received additional user input can include a location for the event and/or a confirmation of the one or more selected individuals. A particular user interaction with the client device can include the user touching a screen of the client device and/or the user engaging an input device operatively connected to the client device.

Particular embodiments of the subject matter described in this specification can be implemented to realize one or more of the following advantages. The subject matter can be implemented to assist in determining a general location of individuals and/or objects while consuming a minimal amount of power. In some implementations, this can allow the users of a client device to determine the general location of their contacts, which can help identify a convenient meeting location. Because the technique uses a minimal amount of power, it can be employed more often and in conjunction with the execution of other applications on the user's client device. The subject matter can also be implemented to present a clearly organized schedule of events and/or messages. In some cases, this can help users better manage their social and/or professional calendar which can allow for more effective scheduling and planning of events. Some implementations of the subject matter can facilitate easier organization of events by, for example, suggesting relevant individuals to invite to events. Such individuals can, in some instances, include individuals that are not members of the social network being used to organize the event. As another example of the easier organization of events, some implementations of the subject matter can facilitate inputting details about and sending invitations to an event with a limited number of user interactions with a client device.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system that can be used in implementations of this disclosure.

FIG. 2 illustrates an example geofence network.

FIG. 3 is a flow chart showing an example method for determining the location of a client device using geofences.

FIG. 4 illustrates examples of the creation of geofences in a geofence network.

FIG. 5 illustrates another example of the creation of geofences in a geofence network.

FIG. 6 illustrates an example graphical user interface for a schedule provided on a client device.

FIG. 7 illustrates example views of the graphical user interface demonstrating an example technique for ordering items.

FIG. 8 illustrates an example of ordering the items of a schedule according to an implementation of this disclosure.

FIG. 9 is a flow chart showing an example method for organizing a schedule.

FIG. 10 illustrates an example concatenation of multiple groups of items shown in a graphical user interface.

FIG. 11 illustrates an example visual indicator indicating that a new item has been received.

FIG. 12 is a flow chart showing an example method for suggesting potential participants for an event.

FIG. 13 illustrates an example of a mobile computer device that can be used to implement the techniques described in this disclosure.

FIG. 14 is a flow chart showing an example method for creating an event and distributing invitations.

### DETAILED DESCRIPTION

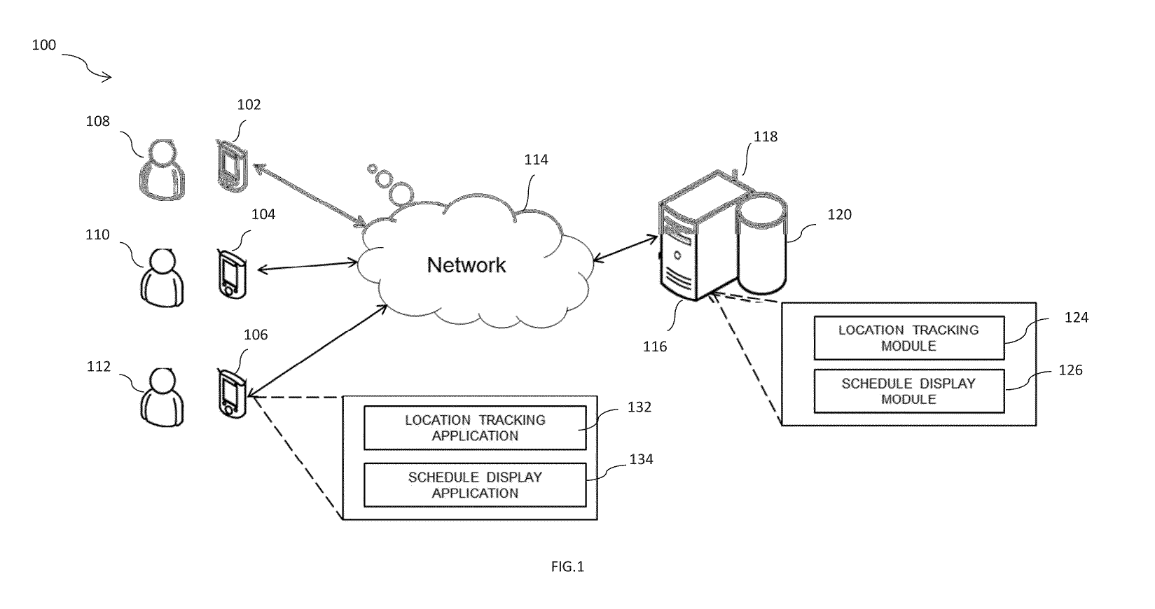

Implementations of this disclosure relate to systems and methods for tracking location and scheduling events. FIG. 1 is a block diagram showing an example system 100 on which the subject matter of the present disclosure can be implemented. System 100 includes client devices 102, 104, 106 that are configured to communicate with a server system 116 over a network 114. Client devices 102, 104, 106 have respective users 108, 110, 112 associated therewith. The server system 116 includes at least one computing device 118 and memory 120. Although only client devices 102, 104, 106 and server system 116 are shown in the figure, example system 100 can include many more client devices and servers which are not shown.

Network 114 can include a large computer network, examples of which include a local area network (LAN), wide area network (WAN), the Internet, a cellular network, or a combination thereof connecting a number of mobile client devices, fixed client devices, and server systems. The network(s) included in network 114 can provide for communications under various modes or protocols, examples of which include Transmission Control Protocol/Internet Protocol (TCP/IP), Global System for Mobile communication (GSM) voice calls, Short Electronic message Service (SMS), Enhanced Messaging Service (EMS), or Multimedia Messaging Service (MMS) messaging, Ethernet, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. Communication can occur through a radio-frequency transceiver. In addition, short-range communication can occur, e.g., using a BLUETOOTH, WiFi, or other such transceiver system.

Client devices 102, 104, 106 enable respective users 108, 110, 112 to engage a GUI that is associated with at least one application. The application(s) can be stored on and executed by the client device 102, 104, 106 or the server system 116.

In example system 100, client devices 102, 104, 106 are illustrated as mobile computing devices. It is noted, however, that client devices 102, 104, 106 can include, e.g., a desktop computer, a laptop computer, a handheld computer, a television with one or more processors embedded therein and/or coupled thereto, a tablet computing device, a personal digital assistant (PDA), a cellular telephone, a network appliance, a camera, a smart phone, an enhanced general packet radio service (EGPRS) mobile phone, a media player, a navigation device, an electronic messaging device, a game console, or a combination of two or more of these data processing devices or other appropriate data processing devices. In some implementations, a client device can be included as part of a motor vehicle (e.g., an automobile).

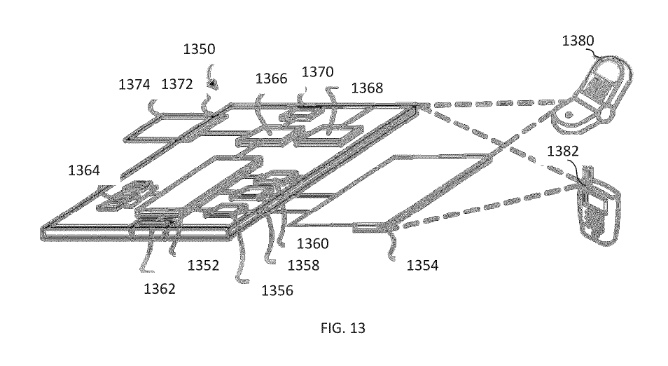

Client devices 102, 104, 106 can execute applications for tracking location 132 of the client device, displaying content related to a user's schedule 134, and facilitating social networking 136. The applications 132, 134, 136 allow for execution of the methods described in this specification, and can be implemented as software, hardware or a combination of software and hardware that is executed on a processing apparatus, such as one or more computing devices (e.g. as described in relation to element 1352 of FIG. 13). In various implementations, client devices 102, 104, 106 can be enabled such that they execute one, all, or any combination of these applications.

The applications 132, 134, 136 can be hosted by a corresponding location tracking module 124, schedule display module 126, and social networking module 128. The modules 124, 126, 128 can be implemented as software, hardware or a combination of software and hardware that is executed on a processing apparatus, such as one or more computing devices.

### Location Tracking Application

In many instances, it can be useful to track the location of individuals and/or objects. Although the discussion in this specification will generally relate to tracking the location of individuals, for example, in conjunction with scheduling a meeting with those individuals, the techniques described can also be employed for other purposes and to track the location of other objects as well, for example, animals or vehicles.

In order to coordinate a meeting between individuals it is often desirable to determine at least a general idea of each individual's location. Not only can this knowledge help identify those individuals for which a meeting is geographically realistic, but it can also help identify a convenient location for the meeting. Many techniques are known for determining location. Among the most popular techniques is the employment of global positioning system (GPS) technology. This technique involves the continuous receipt by a GPS antenna (sometimes located on a mobile device carried by an individual, e.g., as described in relation to element 1370 of FIG. 13) of time-stamped signals sent by satellites located in outer space. Location is then determined based on the time it takes the signals to arrive. Although this technique can provide accurate location data, it presents a significant drawback in that it requires the mobile device to continuously process signals, usually using an application processor (e.g. as described in relation to element 1352 of FIG. 13). Such processing consumes a significant amount of power and rapidly drains the client device's battery. With the growing need for mobile devices (e.g. smartphones) in everyday life, a quickly-draining battery can present a serious inconvenience for the device's owner.

Another technique for determining an individual's location is the use of geofences. A geofence is a virtual parameter that can be designed in a desired size or shape. In example situations, whenever a geofence enabled device (e.g. a smartphone) crosses the threshold of a geofence boundary it sends a notification to an administrator, which can either be an application located on the client device itself or a server system. Such a technique allows the administrator to determine the location of the geofence enabled device to a level of accuracy determined by the size of the geofence. For example, if a geofence has a 1 mile radius, and the administrator receives a notification that a geofence enabled device has entered the geofence (and has not received a subsequent notification that the device has exited the geofence), the administrator knows the device's location to be somewhere within that 1 mile radius. Applications that rely on geofencing to determine location consume significantly less power than applications that use traditional GPS techniques. Unlike some GPS applications, applications that rely on geofencing need not be open and running at all times that location is being monitored, which allows the high power-consuming application processor to remain asleep most of the time. Instead such applications determine location by relying primarily on operations that run independently of and consume less power than the application processor, for example, the client device's operating system, or in some implementations its cellular modem (e.g. as described in relation to element 1366 of FIG. 13). In implementations that track location using a cellular modem, the modem can process signals from cell towers and triangulate to determine the device's location. Thus, the application processor is required to be awake much less often and is only accessed intermittently, for example, when the user engages a GUI associated with the location tracking application 132 or as a back-up when the operating system and/or cellular modem are unable to determine location (e.g. are out of range of a cell tower).

Although the geofencing technique consumes less power than the GPS technique, it still presents power consumption concerns. In particular, monitoring geofences still consumes some power, and the more geofences that are monitored, the more power is consumed. Thus, in some instances, it can be desirable to advantageously remove geofences from the monitored network to conserve power. It can be particularly advantageous if the geofences removed are those least likely to provide relevant location data.

Implementations of the present disclosure relate to power efficient methods for tracking location, for example, through the use of geofencing techniques. In particular, some implementations relate to techniques that can consume even less power than traditional geofencing techniques, by employing systems and methods for the advantageous removal of geofences from a geofence network. In certain implementations, individuals can execute a location tracking application 132 located on their client device or one or more servers accessible from the client device. The client device executing the location tracking application 132 can interact with a network of geofences, and send notifications upon crossing the threshold of a geofence. The notifications can be sent to the location tracking application 132 itself, to a central server system 116, or to any other desired location. In some implementations, use of the location tracking application 132 can allow individuals to determine the general location of other individuals that are also using the location tracking application 132. In such implementations, the client device of each individual executing the application can send notifications to a central server system 116 upon entering or exiting geofences in a geofence network, which allows the server system 116 to determine the relative location of each client device. The server system 116 can then communicate the location of each client device to the other client devices, for example, over the network 114. Thus, in some cases, an individual can be informed of the locations of other client devices upon engaging a GUI related to the location tracking application 132. In some instances, the server system 116 will only communicate to a client device the locations of other client devices that are affiliated with that client device. Client devices may become affiliated through the exchange and acceptance of an affiliation request (sometimes called a “friend request”), or other well-known techniques of affiliation.

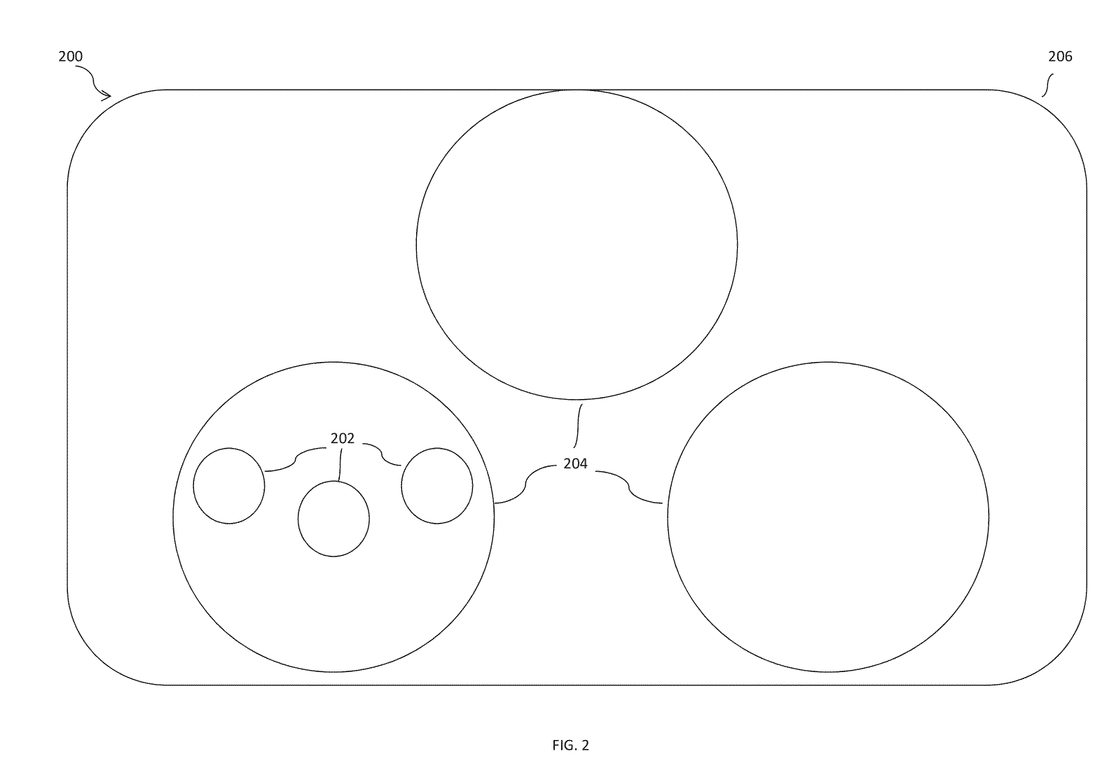

FIG. 2 shows an example geofence network 200. In some instances, the geofence network 200 contains all geofences of the same size. In other instances, the geofence network 200 contains geofences of differing sizes. For example, the geofence network can contain at least one first-sized geofence 202, at least one second-sized geofence 204, and at least one third-sized geofence 206. In such instances, a first-sized geofence 202 can, but is not required to be, encompassed by a second-sized geofence 204, and a second-sized geofence 204 can, but is not required to be, encompassed by a third-sized geofence 206. In some cases, the geofences can overlap with one another, regardless of size. For purposes of a non-limiting example, the first-sized geofence can have a radius of approximately 0.6 miles (1 km), the second-sized geofence can have a radius of approximately 10 miles, and the third-sized geofence can have a radius of approximately 60 miles. The geofences can also be of any desirable shape, for example, a polygon, a circle, an ellipsoid, a quadrilateral, a triangle, or any custom shape designated by geographic or man-made landmarks.

In some implementations, the geofence network 200 is designed such that is can only contain a limited number of geofences. As discussed above, such limitations can be imposed to prevent excessive power consumption by the client devices interacting with the network 200. In some instances, the limitation is of the total number of geofences contained in the network 200. In other instances, the limitation is of the number of geofences of a particular size contained in the network 200. In such instances, the limitations may be different for different sized geofences. For example, a geofence network may be permitted to contain a higher number of smaller geofences than larger geofences. For purposes of a non-limiting example, with reference to FIG. 2, the geofence network 200 may have a limit of 3 first-size geofences and a limit of only 1 third-size geofences.

As discussed below, in some cases, new geofences are generated in the network 200 when client devices are activated in new locations. Thus, in implementations that impose limits on the number of geofences, as new geofences are added to the network 200 it can become necessary to remove geofences from the network 200 as well.

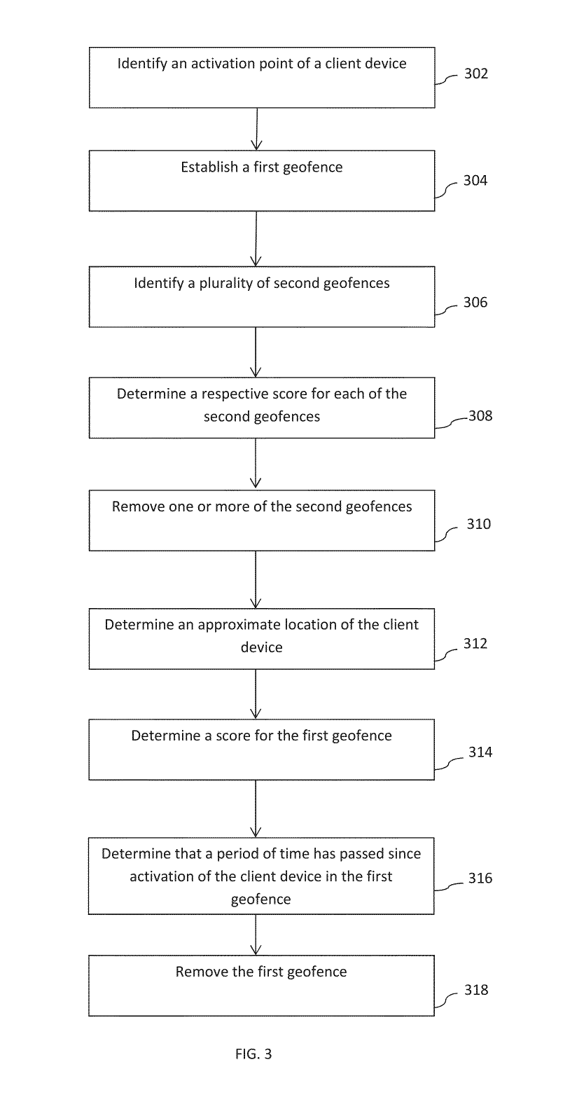

FIG. 3 is a flow diagram of an example method for determining the location of a client device using a geofence network. The method can include identifying 302 an activation point of the client device, which can be a geographic location. Activation can occur when the user interacts with the client device in a particular way, for example, launching the location tracking application 132 or bringing a GUI related to the location tracking application 132 into view on the client device's screen. In some instances, the activation point can be determined to a high degree of accuracy through use of a GPS antenna located on the client device. However, unlike traditional GPS tracking systems in which the GPS antenna and application processor remain engaged and continually process signals to determine location, examples of the present method only require the GPS antenna and application processor to be engaged long enough to identify the activation point. Once the activation point has been identified, location can be determined using geofences, and the application processor can be disengaged (e.g. put to sleep).

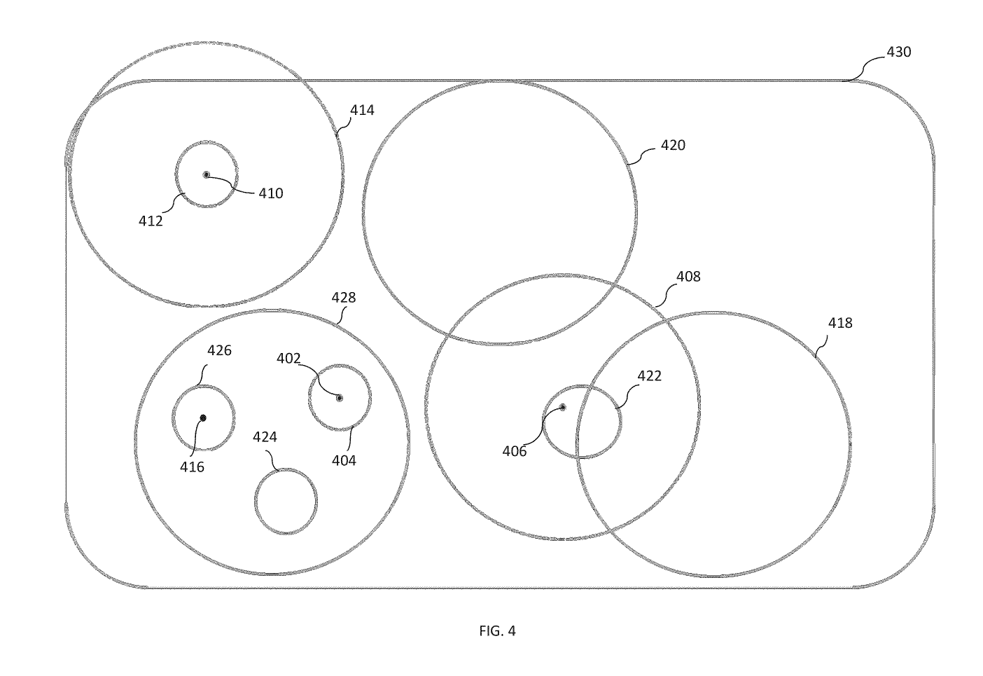

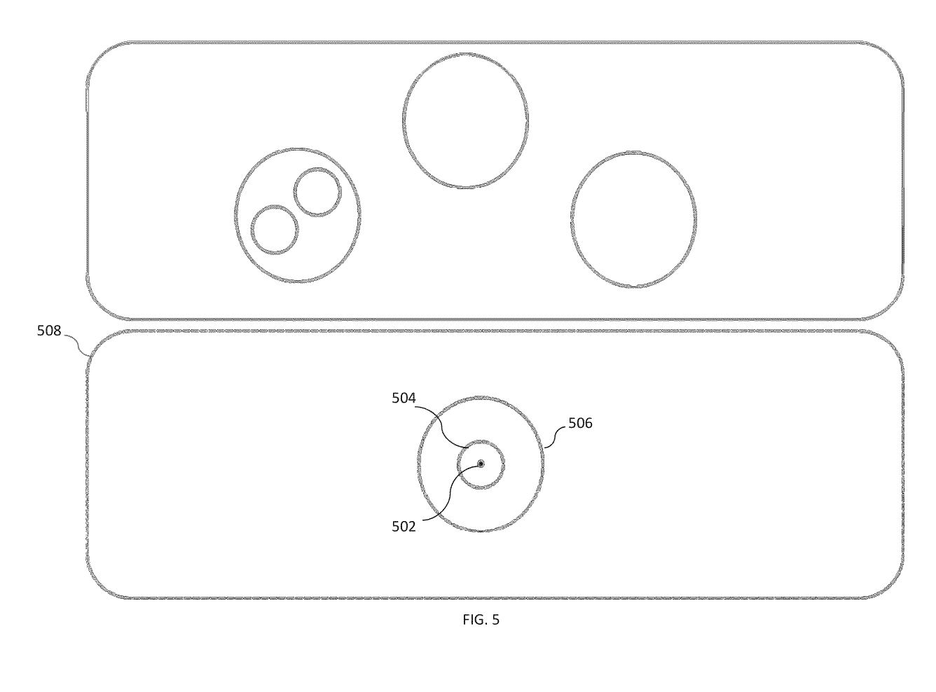

The method can include establishing 304 a first geofence. In some implementations, a first geofence is only established if the activation point is not located within an already existing geofence. In other implementations that include geofences of different sizes, a first geofence of a particular size may only be established if the activation point is not located within an already existing geofence of that size. FIG. 4 shows examples of situations in which a geofence may be established. As one example, in an implementation having a first-sized geofence, a second-sized geofence, and a third-sized geofence, an activation may occur at an activation point 402 that is within a second-sized geofence 428 and a third-sized geofence 430, but not a first-sized geofence. In such instances, a first-sized geofence 404 encompassing the activation point 402 can be established. As another example, an activation may occur at an activation point 406 that is within a first-sized geofence 422 and a third-sized geofence 430, but not a second-sized geofence. In such instances, a second-sized geofence 408 can be established encompassing the activation point 406. In another example, an activation may occur at an activation point 410 located within a third-sized geofence 430, but not within a first-sized geofence or a second-sized geofence. In such instances, both a first-sized geofence 412 and a second-sized geofence 414 can be established encompassing the activation point 410. In another example, if an activation occurs at an activation point 416 within a first-sized geofence 426, a second-sized geofence 428, and a third-size geofence 430, then a new geofence may not be established at all. FIG. 5 shows an example situation where an activation occurs at activation point 502 that is not located in a first-sized geofence, a second-sized geofence, or a third-sized geofence. In such instances, a first sized geofence 504, a second-sized geofence 506, and a third-sized geofence 508 can all be established encompassing the activation point 502. The new geofences can be established in any location that encompasses the relevant activation point, for example, such that they are centered on the relevant activation point.

The above discussion gives a non-exhaustive list of examples of when geofences can be established in a particular implementation containing a particular combination of geofence sizes. However, geofences can be established whenever a given set of conditions is satisfied, for example, a new geofence can be established encompassing each new activation point regardless of whether the activation point is already located in a geofence of that size, or a new geofence may only be established if a new activation point is located beyond a certain distance away from an existing geofence. Further, the geofences can be established in any desirable shape or size, and do not need to be established as the same shape or size as existing geofences.

In some instances, the establishment of new geofences results in the geofence network 200 either exceeding its limit of permitted geofences or having redundant geofences. For example, if the example network shown in FIG. 4 has a limitation of 3 first-sized geofences, an activation at activation point 402 and the subsequent establishment of first-sized geofence 404 would result in the geofence network containing 4 first-sized geofences which exceeds the limit. As another example, an activation at activation point 406 and the subsequent establishment of second-sized geofence 408 results in an overlap of geofence 408 with geofence 418 and geofence 420, which can be redundant. In such situations, it can be necessary to remove at least one geofence from the geofence network 200 to, for example, reduce the power consumption of the client devices interacting with the network 200.

The method can include identifying 306 a plurality of second geofences, which in some cases can be potential candidates for removal. In some instances the second geofences and the first geofence have geographic areas of the same size. In other instances the second geofences and the first geofence have areas of different sizes; in such instances, a particular second geofence can encompass the geographic area of the first geofence or one of the other second geofences.

In certain implementations, the method can include determining 308 a respective score for each of the second geofences. In such implementations, each geofence can have a score associated with it based on, for example, a number of previous activations of the client device when the user was located within the geofence. In some instances, the score can be a weighted combination of previous activations within the geofence. Such a weighted combination can include actualizing the score with a decay period, for example, a daily decay. As a non-limiting example, if the daily decay were set to 0.9, then an activation within the geofence 2 days ago would count 0.9̂2 towards the geofence's score, and an activation 4 days ago would count 0.9̂4 towards the geofence's score. In some cases, a time period can be set such that only one activation per time period counts towards the geofence's score. For example, the time period can be 3 hours. Each geofence's score can be stored on either the client devices or the server system 116. In example instances, scores can be computed efficiently by incrementally storing only the geofence's aggregate score with a timestamp of the last activation within the geofence. In such instances, following each new score-altering activation, the geofence's previous score can be discarded.

The method can include selecting one or more of the second geofences and removing 310 the selected second geofences. In some implementations, however, there is an overarching rule that the geofence in which the client device is currently located is not removed. In some instances, the selected and removed geofence(s) can be all those that overlap with the established first geofence, or in some cases those that overlap with and are the same size as the established first geofence. In these instances, with reference to FIG. 4, both geofence 418 and geofence 420 would be selected and removed. In other instances where at least two geofences overlap with the established first geofence, or in some cases where at least two geofences overlap with the established first geofence and are the same size as the established first geofence, the selected and removed geofence is the geofence having a particular score, for example, the lowest score or the highest score. In these instances, whichever geofence had a particular score, for example the lowest score, between geofence 418 and geofence 420 would be selected and removed. In other instances, the selected and removed geofence is simply the geofence having a particular score, or in some cases the geofence of a particular size having a particular score. For example, the particular score can be the lowest score or the highest score. An example of a situation where geofences can be selected and removed on this basis is when establishment of the first geofence results in the geofence network exceeding its limit. For example, assuming the geofence network in FIG. 4 has a limit of 3 first-sized geofences, activation of activation point 402 and the subsequent establishment of first-sized geofence 404 would result in the selection and removal of whichever first-sized geofence had a particular score, for example the lowest score among geofence 422, geofence 424, and geofence 426.

In some implementations, regardless of whether geofences are established or removed, the method can include determining 312 an approximate location of the client device based on the geographic area of the smallest sized geofence encompassing the client device.

In some implementations, the method can include determining 314 a score for the established first geofence based on the score of a removed second geofence. For example, the established first geofence may inherit the score of the removed second geofence. In instances where more than one second geofence is removed, the first geofence may inherit the score of the removed geofence having the highest score, or in some cases may inherit the aggregate of all the scores of the removed geofences. In some cases, the score of the first geofence may be calculated using the score of the removed second geofence, for example, by adding a predetermined amount or multiplying by a predetermined multiplier.

The method can also include removal of a geofence based on the passage of a period of time since an activation of a client device within the geofence. In certain implementations, only geofences of a certain size can be removed based on this criteria. In some instances, this criteria can be used to remove the established first geofence. The method can include determining 316 that a period of time (e.g. 1 month) has passed since an activation of the client device within a given geofence, and based on that determination, removing 318 the geofence.

### Jump Scrolling

In order to schedule events with a group of contacts it can be desirable to reference a well-organized schedule of events as well as communications regarding the events. In some instances, it can be desirable for this schedule to be presented on the screen of a mobile client device such that it can be carried and referenced by the user in a wide variety of locations. Schedules, including those that can be referenced on the screen of a mobile client device are known, however, those currently available include a number of drawbacks. Many schedules simply list events in the order they are received or accepted by the user, which often requires the user to navigate among events of low relevance. For example, at 10 am a user may accept an invite to attend a party occurring in 3 months, and at 10:30 am accept another invite to go out to dinner that evening. In many current schedules, the user would be required to navigate through content related to the party occurring in 3 months before seeing content related to the event happening that evening, because the party was accepted first. Other schedules will automatically enter an event or an event request in a calendar on the date on which the event occurs. This approach requires users to select or navigate to future calendar dates in order to determine the events scheduled on those dates, which is a process that can require numerous clicks or steps. Further, in order to navigate to a future calendar date, the user must already know the date on which the event occurs, which defeats a significant (though not the only) purpose of having a schedule in the first place. Still other schedules only display events, and do not display communications or messages related to those events (or potentially other topics as well).

Implementations of the subject matter disclosed in this specification relate to a clearly organized and easily navigable schedule provided on a client device, for example, client devices 102, 104, 106. The user may interact with the schedule though a GUI provided on the client device, for example, through execution of a schedule display application 134 located on the client device, or in some cases hosted by a schedule display module 126 located on a server system 116.

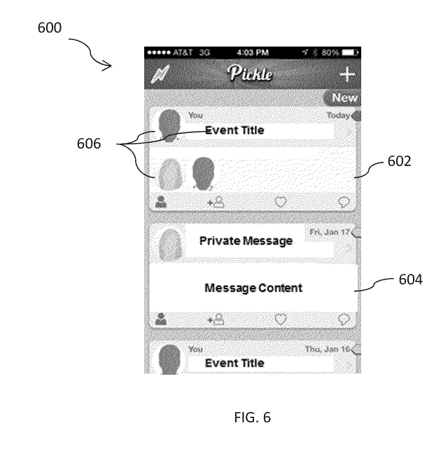

FIG. 6 shows an example GUI 600 which a user can view or engage during execution of the schedule display application 134. The GUI 600 lists the user's events 602 and/or messages 604 either initiated by the user or received from other individuals. Each item includes information 606 about the event and/or message, for example, the initiator, the title, and the participants. In some implementations, the initiator and/or participants can be represented with a graphical representation such as, for example, a digital picture or a logo.

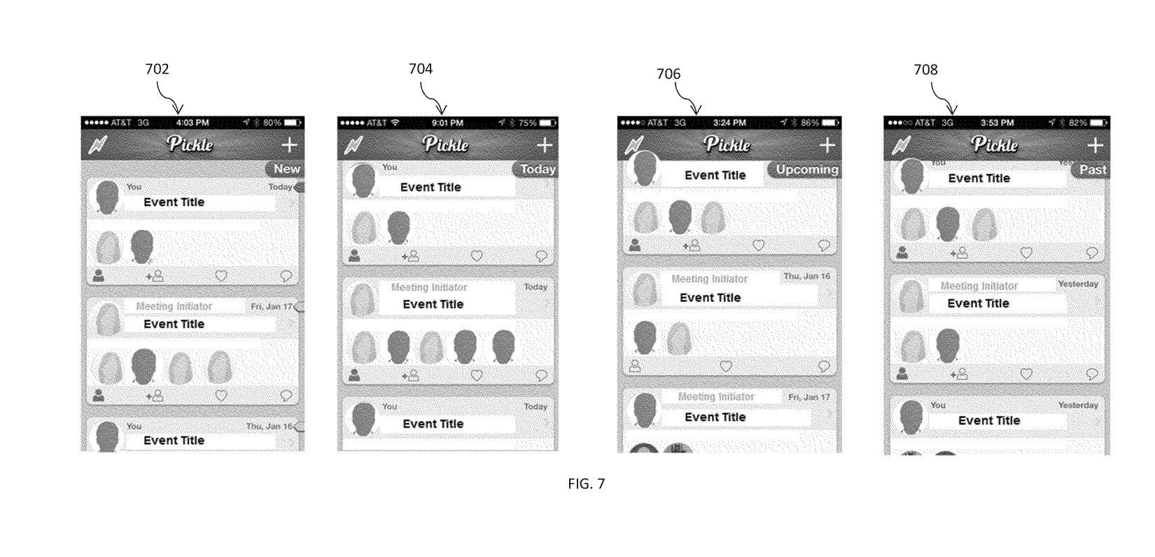

In some implementations, the events and/or messages are ordered in particular ways based on particular characteristics associated with the items. Such characteristics can include a date, sender, or location. FIG. 7 shows example views 702, 704, 706, 708 of the GUI 600 which demonstrate an example technique for ordering the items. Each view 702, 704, 706, 708 shows a different grouping that items can be placed into in accordance with the example ordering technique. The views 702, 704, 706, 708 are shown separately in FIG. 7 to show examples of visible views of the GUI 600 at particular times. However, in some implementations, the GUI 600 is scrollable, and thus, a user can scroll between the views 702, 704, 706, 708. In other implementations, the GUI may not be scrollable and the user can access the different grouping by selecting a link that brings the user to a separate page for each grouping. In implementations having a scrollable GUI 600, the order of the groupings shown in FIG. 7 is non-limiting, and any grouping can appear at any location along the scrollable GUI 600. The GUI 600 can be scrolled using a finger or stylus if the client device has a touchscreen, or with an input device such as, for example, a mouse or a keyboard.

In the example implementation, the first grouping shown in view 702, displays items that are new or unviewed. Items located in the unviewed grouping are those that the user has not yet scrolled past, or in some cases not yet selected. In some implementations the unviewed items can be identified with a graphical representation in the GUI, for example, by being displayed in a different color or text, or marked with an identifying graphic. Within the unviewed grouping the events and/or messages can be ordered in any desired order, for example, by time of receipt or importance. In some implementations, only certain types of received content (e.g. only events or only messages) can be grouped in the unviewed grouping. In certain implementations, each unviewed item can have a date associated with it. In some instances, the date associated with an item, either an event or a message, can be the date the item was received. In other instances, the date associated with an item can depend on the type of item. For example, the date associated with an event can be the date the event occurs, while the date associated with a message can be the date the message is received. In certain implementations, items in the unviewed grouping can also be ordered by their associated date. In such implementations, items having more recent dates can occur before items having less recent dates.

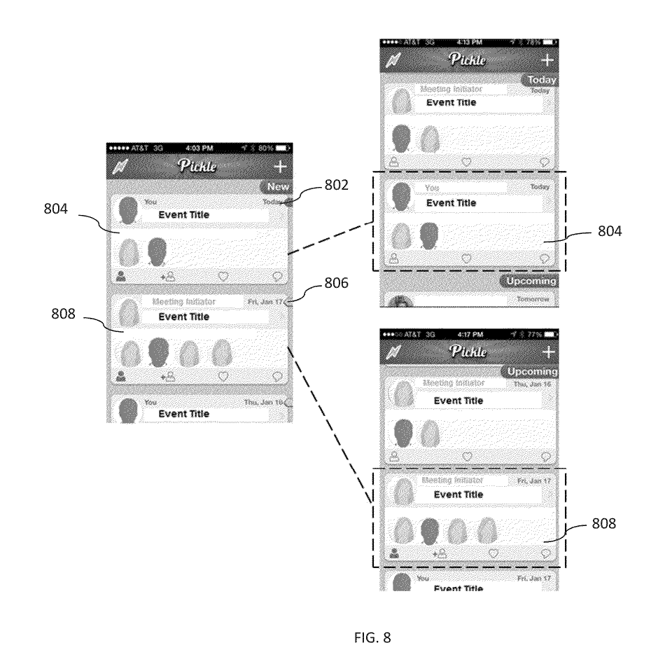

The second grouping, an example of which is shown in view 704, displays events and/or messages that have been viewed and which have an associated date that is the same as the current date (i.e. “today”). Items can become located in the second grouping in a number of ways. One example is a situation where an item is viewed for the first time on its associated date. In this situation, in some implementations, the item can automatically be relocated from the first (unviewed) grouping into the second grouping. An example of this process can be seen in FIG. 8. As indicated in the figure, the date 802 associated with event 804 is the current date. Upon being viewed or selected by a user, the event 804 is relocated from the first grouping (represented in the figure under the “New” heading) to the second grouping (represented in the figure under the “Today” heading). Another example way in which an item can become located in the second grouping is when an item was first viewed on a day before its associated date, and thus was originally relocated from the first grouping into the third (upcoming) grouping (as discussed below), but was then later relocated from the third grouping into the second grouping when the current date became its associated date. Another example occurs in an implementation where an item's associated date is the date of receipt and the implementation either does not include a first grouping or the received item is not eligible to be grouped in the first grouping. In such implementations, the item may be placed directly in the second grouping upon receipt. Within the second grouping, items can be ordered in any desired order, for example, by associated date, time of receipt or importance.

The third grouping, an example of which is shown in view 706, displays items that have been viewed and which have an associated date that follows the current date (i.e. a future date). Items can become located in the third grouping in a number of ways. One example is a situation where an item is viewed for the first time on a date before its associated date. In this situation, in some implementations, the item can automatically be relocated from the first grouping into the third grouping. An example of this process can be seen in FIG. 8. The date 806 associated with event 808 is a date that follows the current date. Upon being viewed or selected by a user, the event 808 is relocated from the first grouping (represented in the figure under the “New” heading) to the third grouping (represented in the figure under the “Upcoming” heading). Another example way in which an item can become located in the third grouping occurs in an implementation where an item's associated date is a date in the future and the implementation either does not include a first grouping or the received item is not eligible to be grouped in the first grouping. In such implementations, the item may be placed directly in the third grouping upon receipt. Within the third grouping, items can be ordered in any desired order, for example, by associated date, time of receipt or importance.

The fourth grouping, an example of which is shown in view 708, displays items that have an associated date that has already passed. In some instances, viewed item can be relocated from the second grouping into the fourth grouping once the date associated with the item passes. In some implementations, unviewed items whose associated date passes before they are viewed can be relocated from the first grouping to the fourth grouping without ever being viewed. In other implementations, unviewed items whose associated date passes before they are viewed remain in the first grouping until they are viewed, at which point they are relocated to the fourth grouping. Within the fourth grouping, items can be ordered in any desired order, for example, by associated date, time of receipt or importance.

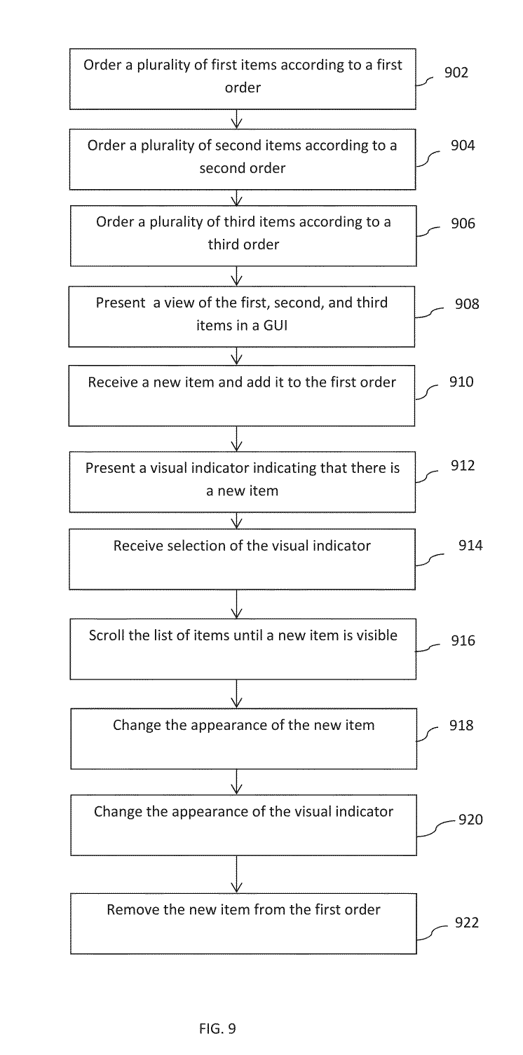

FIG. 9 is a flow chart of a method for organizing a schedule in accordance with an implementation of the present disclosure. The method can include ordering 902 a plurality of first items according to a first order. In some instances, the plurality of first items can be new or unviewed items and can be grouped in the first grouping discussed above. The method can include ordering 904 a plurality of second items according to a second order. In some instances, the plurality of second items can be items that have been viewed and have an associated date that is the same as the current date, and can be grouped in the second grouping discussed above. The method can include ordering 906 a plurality of third items according to a third order. In some instances, the plurality of third items can be items that have been viewed and have an associated date that follows the current date, and can be grouped in the third grouping discussed above. In some implementations, each of the first items, second items, and third items have a respective date associated therewith. The above categories of items are meant as examples, and in certain implementations any of the first, second, or third items can be items that meet any set of predetermined criteria, for example, having an associated date that has already passed, being associated with a particular location, or being received from a particular sender. Further, although three groupings are discussed in this specification, in certain implementations, less or more groupings may be used.

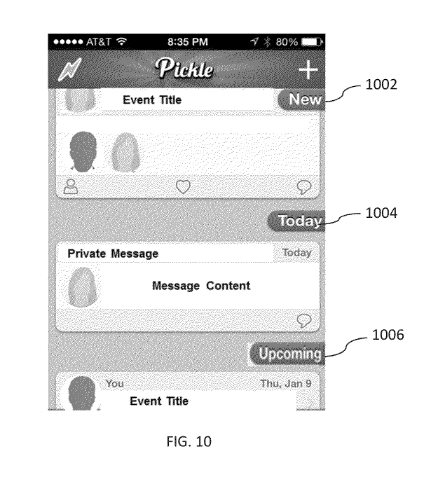

The method can include presenting 908 a view of the ordered items in a GUI displayed on the screen of a user's client device. In some instances, the view can include a concatenation of the ordered first items, the ordered second items, and the ordered third items. In some instances the view can be of a concatenation of unviewed items 1002, viewed items 1004 having a respective date the same as the current date, and viewed items 1006 having a respective date that follows the current date, as shown, for example, in FIG. 10.

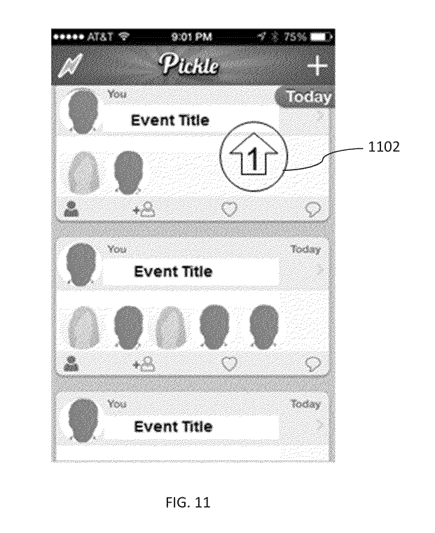

The method can include receiving 910 a new item and adding it to any of the groups of ordered items, for example, the ordered group of first items, which in some cases can include unviewed items. In some cases, the new item is generated by the user of the client device. In other cases, the new item is received by the user of another client device. In some instances, the new item is added to a group of ordered items such that it is not visible in the GUI, which can be at a location either above or below the visible portion of the GUI. In such instances, the GUI may present a visual indicator 1102 indicating that there is a new item, as shown, for example, in FIG. 11. The visual indicator can be any graphical representation that informs a user of the new item, for example, an arrow, an exclamation mark, or a textual message. In some instances the visual indicator may convey additional information, for example, the number of new items or the direction in which the GUI needs to be scrolled in order to view the new items. The visual indicator can be positioned at any location in the visible view of the GUI, for example, an upper or lower edge. The method can include receiving 914 user selection of the visual indicator. In implementations where the client device has a touchscreen, users can select the indicator using their finger or a stylus. In other instances, an input device such as, for example, a mouse or a keyboard can be used. Alternatively, in implementations having a voice user interface (“VUI”), the indicator can be selected via the user's voice (e.g. as described in relation to element 1360 of FIG. 13).

The method can include scrolling 916 the list of items until the new item is visible. In some cases, scrolling is done automatically by the GUI, for example, in response to the user's selection of the visual indicator. In other cases, the user can scroll the GUI manually. In some instances, after the new item is visible, the method can include changing 918 the appearance of the new item to indicate that it has been viewed, for example, changing its color, changing its text, or removing certain graphical representations. In some instances, after the new item is visible, the method can include changing 920 the appearance of the visual indicator to indicate that the new item has been viewed. Such appearance changes can include, for example, decrementing a number presented on the visual indicator or removing the indicator from the GUI. In some implementations, after the new item has been viewed it can be removed from the first order. For example, in instances where the first order is the grouping of unviewed items, the item can be removed from the grouping of unviewed items and placed in either the second, third, or fourth groupings as discussed above.

Although the above discussion refers to organizing a schedule based on dates associated with the items listed, the disclosed subject matter is not limited on this basis. The same methods and systems can be employed to organize received items based on any predetermined criteria. As one example, rather than being ordered based on a respective date, the received items can be ordered based on the sender. In such an example, the different groupings can relate to different groups of contacts, for example, co-workers, friends, and family. In other examples, the received items can be ordered based on the type of event or location of the event.

### Social Networking

When organizing an event among a group of individuals, it can often be desirable to identify potential participants for the event. This process can sometimes be aided through the use of a social network. As used in this specification, a social network of an individual is a group of other individuals with whom the individual has relationships known by a system. The relationships can be implicit or explicit, and in either case the relationships identify the group of individuals and the individual as a proper subset of individuals within a network. Examples of groups identified by explicit relationships include individuals belonging to a “friends lists” of an individual within a social network, individuals that are “linked to” an individual within a professional network, and individuals that otherwise explicitly identify themselves as belonging to a group so as to form a group that is distinct from the larger group of all individuals. Other types of explicit relationships are possible. Examples of groups identified by implicit relationships include individuals located near a common location (e.g., individuals within a predefined distance of a city center) and individuals that are otherwise implicitly identified so as to form a group that is distinct from the larger group of all individuals. In some instances, a social network can be defined by users of an application, for example, social networking application 136, that enables users to communicate and interact with one another.

Although social networks are well known, the options offered by current social networks for identifying potential participants for an event have significant drawbacks. Often times in order to be invited to an event organized using the social network, an individual must become a user (or “member”) of the social network, for example, by downloading an application. Some current social networks only allow an event organizer to invite individuals that are already members of the social network, and prevent inviting non-members. Additionally, some current social networks do not differentiate among the members of the social network when providing a list of potential participants to an event organizer. Instead, the social network simply provides a bulk list organized in a generic fashion, for example, alphabetically, of every individual that the event organizer is affiliated (i.e. “friends”) with within the social network. This requires the event organizer to navigate through his or her entire list of friends in order to select participants for a particular event; an onerous process and one that increases the likelihood that a desired participant will be inadvertently excluded. Further, current processes do not distinguish between friends that are more or less likely to accept an invitation to a particular event. Consider, as one non-limiting example, a particular event organizer that lives in and is attempting to organize an event in Boston using a social network within which he is affiliated with 500 individuals; one such individual is from San Francisco and has interacted with the organizer once 5 years ago, another individual is from Boston and interacts with the organizer every day. In some current social networks, the individual from San Francisco and the individual from Boston would be presented equally as potential participants for the event.

Implementations of the subject matter disclosed in this specification relate to systems and methods that better facilitate the organization of events among individuals, for example, by suggesting a relevant list of potential participants for an event. Such systems and methods can be implemented through execution of a social networking application 136 located on a client device 102, 104, 106, or in some cases hosted by a social networking module 128 located on server system 116.

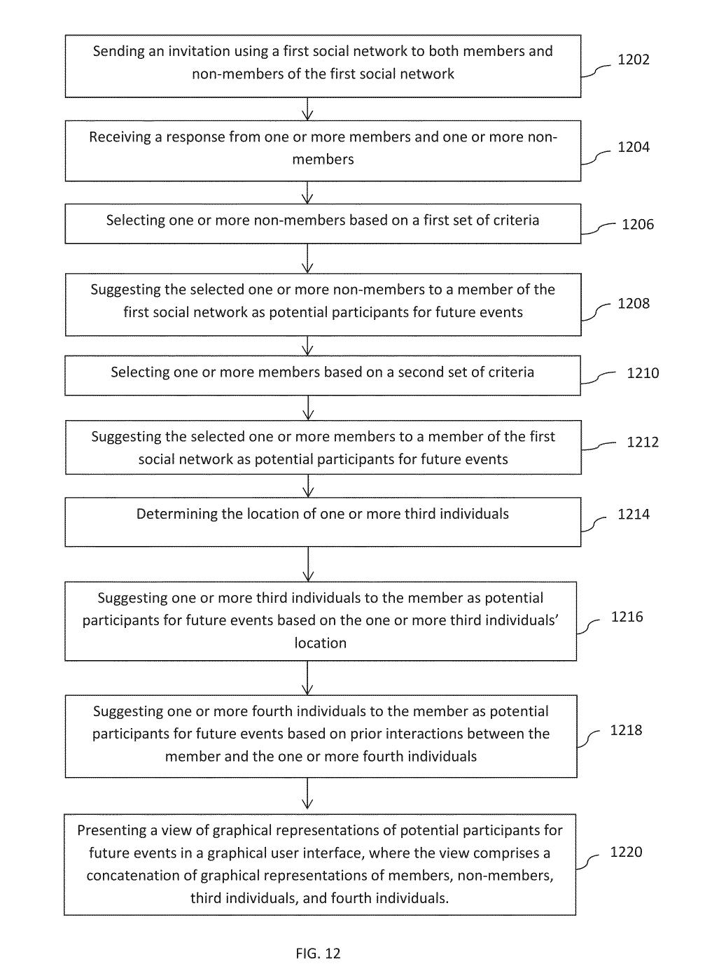

FIG. 12 is a flow chart of a method for suggesting potential participants for an event according to an implementation of this disclosure. The method can include sending 1202 an invitation to individuals for an event scheduled using a social network, for example, through execution of the social networking application 136, where some of the individuals are members of the social network and some are not members. As used in this disclosure, the phrase “members of the social network” refers to individuals who are users of a particular social networking application, for example social networking application 136. The method can then include receiving 1204 responses from such individuals.

In order to send invitations and/or receive acceptances from individuals that are not members of the social network, the social networking application 136 can be enabled to communicate through channels outside of the social network. For example, the social network application 136 can be enabled to communicate through other social networks' communication channels, Short Message Service (“SMS”) messaging, e-mail, or any other communication channel possible using communication interface 1366 (discussed in relation to FIG. 13). In some implementations, invitations to individuals that are not members of the social network can includes means by which the social networking application 136, or in some cases a social networking module 128, can record the non-members response to the invitation. For example, the invitation to a non-member can include a hyperlink, which upon selection by the non-member causes information to be sent to the social network application 136, or social networking module 128. The information can include, for example, the non-member's name and/or whether the invitation was accepted or rejected. Such information can then be stored in a memory, for example memory 120 (discussed in relation to FIG. 1) and/or memory 1364 (discussed in relation to FIG. 13). This capability allows the social networking application 136 and/or module 128 to retain a listing of individuals that are not users of the social networking application 136, but have been invited to an event scheduled using the application 136 and/or accepted such an invitation.

In some implementations, a non-member of the social network can be invited to events scheduled using the social network via multiple different communication channels. In some cases, one member of the social network may invite the non-member to the same and/or different events via different communication channels (e.g. SMS message, e-mail, different social network). In other cases, one member of the social network may invite the non-member to an event using one communication channel, and other members of the social network may invite the non-member to the same and/or different events via different communication channels. In either case, in certain implementations, the social networking application 136 and/or module 128 can review data associated with each communication channel such that it can determine which communication channels are associated with the same individual. For example, if one member of the social network invites a non-member to an event scheduled using the social network via SMS message, another member invites the same non-member to an event scheduled using the social network via e-mail, and another member invites the same non-member to an event scheduled using the social network via a different social network; the social networking application 136 and/or module 128 can determine that the SMS message, e-mail, and different social network communication channels are all associated with the same non-member. Thus, in addition to storing non-members' names, the application 136 and/or module 128 can also store a list of communication channels associated with each non-member, as well as the non-member's response history for each communication channel. This technique can be mutually beneficial to both the members of the social network, as well as the providers. For the members, the social networking application 136 can suggest potential event participants that are not using the application 136, expanding the options of individuals to invite to events. For the providers, the technique can allow for the application 136 to be exposed to a larger number of individuals, potentially allowing for growth of the user-base. In furtherance of this objective, in some implementations, the method can include sending post-invitation communications to non-users that are invited to events organized using the social networking application 136, where such communications solicit such individuals to become users of the application 136. In other implementations, acceptance of an invitation to attend an event scheduled using the social networking application 136 can prompt the automatic download of the application 136 to the non-user's client device.

The method can also include selecting 1206 one or more individuals from the retained listing of non-members and suggesting 1208 such individuals to a member of the social network as potential participants for future events. In some instances, the non-members can be selected based on a set of criteria, which can include any criteria that will result in suggestions that are relevant to a member of the social network. In some cases, for example, the criteria can require that the member for which the suggestion is being provided has received and/or accepted an invitation to attend an event to which the non-member was invited. In other cases, the criteria can require that the member have a particular degree of social indirection with an individual that received and/or accepted an invitation to attend an event to which the non-member was invited. A degree of social indirection between members of a social network is a number of intermediate relationships between the two. For example, in the case of explicit “friend list” type relationships, the degree of social indirection is 0 if the members are friends, 1 if the first member is a friend of a friend of the second member, 2 if the first member is a friend of a friend of a friend of the second member, and so on. The same applies for implicit relationships and combinations of implicit and explicit types of relationships. If two members have a degree of social indirection between them that is greater than zero, the nature of their relationship may depend on the nature of their relationships with individuals to whom they are both related. The above gives a non-exhaustive list of criteria for selection, other examples are possible. In other instances, the non-members can be selected and suggested randomly according to no criteria.

As discussed above, in some implementations, the social networking application 136 and/or module 128 can store multiple communication channels for a given non-member. In some instances, suggesting 1208 an individual for which multiple communication channels are known can comprise making a single suggestion of the individual for a given event, not a separate suggestion for each communication channel. For example, if John Doe is selected to be suggested to a member of the social network as a potential participant for a future event, and social networking application 136 and/or module 128 stores an SMS message and e-mail communication channel for John Doe, then suggesting John Doe to the member can comprise making a single suggestion that the member invite John Doe, not separate suggestions that the member invite John Doe via SMS message and that the member invite John Doe via e-mail.

In some implementations, if the member prompts the application 136 to invite a non-member for which multiple communication channels are known, the application 136 can determine which communication channel or channels to use to communicate with the non-member. In some cases, determination of which communication channel(s) to use can be based on a particular non-member's response history with various channels. For example, if a particular non-member usually responds to invitations sent via SMS message, but rarely to invitations sent via e-mail, the application 136 can send an invitation via SMS message. In other cases, determination of which communication channel(s) to use can be based on generic invitation strategies. For example, the application 136 can be programmed to send an SMS message for events occurring within a shorter timeframe (e.g. 1 day) and an e-mail for events occurring within a longer timeframe (e.g. 1 week). In still further cases, determination of which communication channel(s) to use can be based on feedback received from the non-member. For example, for an event scheduled to take place in 1 week, the application 136 can send an invitation via e-mail; if the non-member responds to the e-mail, the application 136 does not send another invitation, but if the non-member has not responded to the e-mail by a certain time (e.g. 1 day before the event), the application 136 can send another invitation via a different communication channel (e.g. SMS message). The foregoing are solely examples of ways in which the application 136 can determine to send invitations via various communication channels; other examples are possible. In other instances, separate suggestions can be made for each communication channel stored, and the member can determine which communication channels to use to send invitations.

The method can include selecting 1210 one or more members of the social network and suggesting 1212 such individuals to a member of the social network as potential participants for future events. In some implementations, the suggested members may, for example, not be affiliated (“friends”) with the member they are being suggested to. In some instances, the members can be selected based on a set of criteria which can include any criteria that will result in suggestions that are relevant to a member of the social network. The possible sets of criteria for selecting a member of the social network are the same as those for selecting a non-member discussed above. In some cases, the set of criteria used to select non-members and the set of criteria used to select members is the same. In other cases, the sets of criteria are different. In some instances, the members can be selected and suggested randomly according to no criteria.

The method can include suggesting 1216 additional individuals to a member of the social network as potential participants for future events based on such individuals geographic location. For example, the method can include suggesting individuals that are located within a predetermined geographic distance of a member at the time the member is organizing an event. In order to make such suggestions, the method can include determining 1214 the location of the suggested individuals. Example methods for determining location can include use of GPS and/or geofences. Other location-tracking techniques are possible. In implementations using geofences, location can be determined through execution of the location tracking application 132 discussed in this disclosure. In some implementations, the location tracking application 132 and the social networking application 136 can be executed in conjunction with one another, such that the location of members of the social network can be determined.

The method can include suggesting 1218 additional individuals to a member of the social network as potential participants for future events based on prior interactions between the member and the suggested individuals. In some implementations, the suggestion can be based upon the recentness of the last interaction between the member and the suggested individuals. As one example, the suggested individuals can be individuals that the member interacted with during a preceding predetermined period of time. In other implementations, the suggested individuals can be individuals that the member has interacted with a predetermined number of times in a preceding predetermined time period. Other characteristics of prior interactions can provide the criteria for determining which individuals are suggested, as well. A non-exhaustive list of such criteria includes location, time of day, and nature (e.g. professional or social) of a prior interaction. In some implementations, prior interactions are recorded by the social networking application 136. In such implementations, in some instances, the prior interactions that serve as a basis for suggesting individuals are those interactions scheduled using the application 136, and in some cases the suggested individuals are members of the social network. In other implementations, the prior interactions that serve as a basis for suggesting individuals can occur outside of the social network, for example, through a different social network, SMS messaging, or email.

In addition to not providing relevant suggestions of potential event participants, some current social networks offer a cumbersome process for selecting such participants and generating an event invitation. Implementations of the present disclosure not only relate to methods for suggesting relevant event participants, but also methods that facilitate the easier selection of such individuals and generation of an event invitation. The method can include presenting 1220 the user of a client device (e.g. client devices 102, 104, 106) with a graphical representation of potential event participants in a graphical user interface, where the view comprises a concatenation of graphical representations of: (i) non-members suggested in conjunction with step 1208 of the method discussed herein; (ii) members suggested in conjunction with step 1212 of the method discussed herein; (iii) individuals suggested based on geographic location in conjunction with step 1216 discussed herein; and (iv) individuals suggested based on prior interactions in conjunction with step 1218 discussed herein. In some instances, non-members suggested under group (i) can be presented as a single item, regardless of the number of communication channels stored for such individuals. In other instances, non-members suggested under group (i) can be presented multiple times, for example, once for each communication channel stored for such individuals.

The suggested participants can be organized and presented in any combination. As one example, the individuals suggested under groups (i) and (ii) can be presented in a first category, the individuals suggested under group (iii) can be presented in a second category, and the individuals suggested under group (iv) can be presented in a third category. As another example, the individuals in each of groups (i) through (iv) can be presented in separate categories. Other organizations and presentations of the groups are possible. Individuals that fall into two or more groups can be presented in either or all of the groups under which they qualify. For example, in an implementation that organizes individuals suggested based on geographic location and individuals suggested based on prior interactions into separate categories, an individual that is both geographically nearby and interacted with the member recently can, in some cases, be presented in either category. In other implementations the individual can be presented in both categories. A graphical representation of a particular individual can include any graphic that identifies the individual, for example, a digital picture or logo.

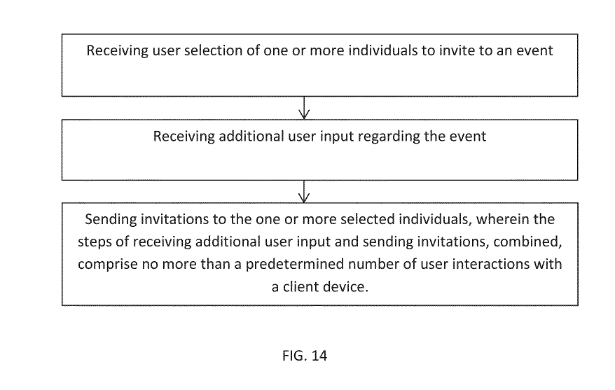

In some implementations, graphical representations of potential participants can be selected by the user of a client device. Examples of selecting a participant can include touching the graphical representation of the individual, using an input device, or identifying the individual by voice into a voice user interface (“VUI”). Upon selection, the participants can be added to the list of invitees for a particular event. In some instances, as shown in FIG. 14, following selection of participants, an event invitation can be distributed with only a limited number of user interactions with the client device, in some cases as few as three. In an example instance, following selection of participants, an event invitation can be distributed with a single user interaction with the client device for each of the following actions: (1) confirm the friend selection; (2) select a location; and (3) confirm sending the invitation. Other actions are possible with the limited number of user interactions, and may be substituted for those in the foregoing example, for example, pulling up a list of locations, pulling up a list of dates and/or selecting a date, pulling up a list of times and/or selecting a time. A particular user interaction with the client device can include, for example, touching a touchscreen, engaging an input device, or speaking into a VUI. This process can be significantly simpler than the process offered by some current social networks, which can require significant user navigation to identify participants and/or input of detailed information regarding the event.

In some implementations, a GUI associated with the social networking application 136 can include a multi-selection interactive control, selection of which can result in multiple potential participants being added to the list of invitees. In some instances, selection of the multi-selection interactive control can result in all suggested potential participants being added to the list of invitees. In other instances, selection of the multi-selection interactive control can result in all potential participants from a particular group being added to the list of invitees, for example, all individuals suggested under group (iii) (e.g. located within a predetermined geographic distance of the member at the time the member is organizing an event). In some cases, following selection of the multi-selection interactive control, the event organizer has the opportunity to de-select certain individuals before invitations are sent.

In some implementations, graphical representations of potential participants that are not members of the social network can include a first interactive control, selection of which causes an invitation to join the social network to be sent to the individual. In some implementations, graphical representations of potential participants that are members of the social network, but are not affiliated (“friends”) within the social network with the member to which they are being suggested, can include a second interactive control, selection of which causes an affiliation (“friend”) request to be sent to the individual. In some implementations, graphical representations of any potential participant can include a third interactive control, selection of which causes the individual to be removed from the list of suggested potential participants.

### Operating Apparatus

FIG. 13 shows an example of a generic mobile computing device 1350, which may be used with the techniques described in this disclosure. Computing device 1350 includes a processor 1352, memory 1364, an input/output device such as a display 1354, a communication interface 1366, and a transceiver 1368, among other components. The device 1350 may also be provided with a storage device, such as a microdrive or other device, to provide additional storage. Each of the components 1350, 1352, 1364, 1354, 1366, and 1368, are interconnected using various buses, and several of the components may be mounted on a common motherboard or in other manners as appropriate.

The processor 1352 can execute instructions within the computing device 1350, including instructions stored in the memory 1364. The processor may be implemented as a chipset of chips that include separate and multiple analog and digital processors. The processor may provide, for example, for coordination of the other components of the device 1350, such as control of user interfaces, applications run by device 1350, and wireless communication by device 1350.

Processor 1352 may communicate with a user through control interface 1358 and display interface 1356 coupled to a display 1354. The display 1354 may be, for example, a TFT LCD (Thin-Film-Transistor Liquid Crystal Display) or an OLED (Organic Light Emitting Diode) display, or other appropriate display technology. The display interface 1356 may comprise appropriate circuitry for driving the display 1354 to present graphical and other information to a user. The control interface 1358 may receive commands from a user and convert them for submission to the processor 1352. In addition, an external interface 1362 may be provided in communication with processor 1352, so as to enable near area communication of device 1350 with other devices. External interface 1362 may provide, for example, for wired communication in some implementations, or for wireless communication in other implementations, and multiple interfaces may also be used.

The memory 1364 stores information within the computing device 1350. The memory 1364 can be implemented as one or more of a computer-readable medium or media, a volatile memory unit or units, or a non-volatile memory unit or units. Expansion memory 1374 may also be provided and connected to device 1350 through expansion interface 1372, which may include, for example, a SIMM (Single In Line Memory Module) card interface. Such expansion memory 1374 may provide extra storage space for device 1350, or may also store applications or other information for device 1350. Specifically, expansion memory 1374 may include instructions to carry out or supplement the processes described above, and may include secure information also. Thus, for example, expansion memory 1374 may be provided as a security module for device 1350, and may be programmed with instructions that permit secure use of device 1350. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1364, expansion memory 1374, memory on processor 1352, or a propagated signal that may be received, for example, over transceiver 1368 or external interface 1362.

Device 1350 may communicate wirelessly through communication interface 1366, which may include digital signal processing circuitry where necessary. Communication interface 1366 may in some cases be a cellular modem. Communication interface 1366 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1368. In addition, short-range communication may occur, such as using a Bluetooth, WiFi, or other such transceiver (not shown). In addition, GPS (Global Positioning System) receiver module 1370 may provide additional navigation- and location-related wireless data to device 1350, which may be used as appropriate by applications running on device 1350.

Device 1350 may also communicate audibly using audio codec 1360, which may receive spoken information from a user and convert it to usable digital information. Audio codec 1360 may likewise generate audible sound for a user, such as through a speaker, e.g., in a handset of device 1350. Such sound may include sound from voice telephone calls, may include recorded sound (e.g., voice messages, music files, etc.) and may also include sound generated by applications operating on device 1350.

The computing device 1350 may be implemented in a number of different forms, as shown in FIG. 13. For example, it may be implemented as a cellular telephone 1380. It may also be implemented as part of a smartphone 1382, personal digital assistant, or other similar mobile device.

### Operating Environment

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving acceptance from one or more first individuals and one or more second individuals of an invitation to attend an event scheduled using a first social network wherein the one or more first individuals are members of the first social network and the one or more second individuals are not members of the first social network;
selecting one or more of the second individuals based on a first set of criteria; and
suggesting the selected one or more second individuals to a member of the first social network as potential participants for future events.

2. The computer-implemented method of claim 1 wherein the first set of criteria requires that the member of the first social network has accepted an invitation to attend the event to which the one or more second individuals were invited.

3. The computer-implemented method of claim 1 wherein the first set of criteria requires that the member of the first social network has received an invitation to attend the event to which the one or more second individuals were invited.

4. The computer-implemented method of claim 1 wherein the first set of criteria requires that the member of the first social network has a degree of social indirection with an individual that received an invitation to attend the event to which the one or more second individuals were invited.

5. The computer-implemented method of claim 1 wherein one or more of the second individuals are members of a second social network, the method further comprising:
sending the invitation to the one or more of the second individuals through the second social network.

6. The computer-implemented method of claim 1 further comprising:
sending the invitation to one or more of the second individuals through Short Message Service (SMS) messaging or e-mail.

7. The computer-implemented method of claim 1 further comprising:
selecting one or more of the first individuals based on a second set of criteria; and
suggesting the selected one or more first individuals to the member of the first social network as potential participants for future events.

8. The computer-implemented method of claim 7 wherein the second set of criteria requires that the member of the first social network has accepted an invitation to attend the event to which the one or more first individuals were invited.

9. The computer-implemented method of claim 7 wherein the second set of criteria requires that the member of the first social network has received an invitation to attend the event to which the one or more first individuals were invited.

10. The computer-implemented method of claim 7 wherein the second set of criteria requires that the member of the first social network has a degree of social indirection with an individual that received an invitation to attend the event to which the one or more first individuals were invited.

11. The computer-implemented method of claim 7 further comprising:
suggesting one or more third individuals to the member of the first social network as potential participants for future events, wherein the one or more third individuals are located within a predetermined geographic distance of the member.

12. The computer-implemented method of claim 11 further comprising:
determining the location of a particular third individual based on geographic location information obtained from the first social network.

13. The computer-implemented method of claim 11 further comprising:
suggesting one or more fourth individuals to the member of the first social network as potential participants for future events, wherein the one or more fourth individuals has interacted with the member within a preceding predetermined period of time.

14. The computer-implemented method of claim 13 wherein the member of the first social network and the one or more fourth individuals interacted via at least one of the first social network, a social network that is different than the first social network, Short Message Service (SMS) messaging, and e-mail.

15. The computer-implemented method of claim 13 further comprising:
presenting a view of graphical representations of potential participants for future events in a graphical user interface, wherein the view comprises a concatenation of graphical representations of the first individuals, the second individuals, the third individuals, and the fourth individuals.

16. A system comprising:
one or more data processing apparatus programmed to perform operations comprising:
receiving acceptance from one or more first individuals and one or more second individuals of an invitation to attend an event scheduled using a first social network wherein the one or more first individuals are members of the first social network and the one or more second individuals are not members of the first social network;
selecting one or more of the second individuals based on a first set of criteria; and
suggesting the selected one or more second individuals to a member of the first social network as potential participants for future events.

17. The system of claim 16 wherein the first set of criteria requires that the member of the first social network has accepted an invitation to attend the event to which the one or more second individuals were invited.

18. The system of claim 16 wherein the first set of criteria requires that the member of the first social network has received an invitation to attend the event to which the one or more second individuals were invited.

19. The system of claim 16 wherein the first set of criteria requires that the member of the first social network has a degree of social indirection with an individual that received an invitation to attend the event to which the one or more second individuals were invited.

20. The system of claim 16 wherein one or more of the second individuals are members of a second social network, and wherein the operations further comprise:
sending the invitation to the one or more of the second individuals through the second social network.

21. The system of claim 16 wherein the operations further comprise:
sending the invitation to one or more of the second individuals through Short Message Service (SMS) messaging or e-mail.

22. The system of claim 16 wherein the operations further comprise:
selecting one or more of the first individuals based on a second set of criteria; and
suggesting the selected one or more first individuals to the member of the first social network as potential participants for future events.

23. The system of claim 22 wherein the second set of criteria requires that the member of the first social network has accepted an invitation to attend the event to which the one or more first individuals were invited.

24. The system of claim 22 wherein the second set of criteria requires that the member of the first social network has received an invitation to attend the event to which the one or more first individuals were invited.

25. The system of claim 22 wherein the second set of criteria requires that the member of the first social network has a degree of social indirection with an individual that received an invitation to attend the event to which the one or more first individuals were invited.

26. The system of claim 22 wherein the operations further comprise:
suggesting one or more third individuals to the member of the first social network as potential participants for future events, wherein the one or more third individuals are located within a predetermined geographic distance of the member.

27. The system of claim 26 wherein the operations further comprise:
determining the location of a particular third individual based on geographic location information obtained from the first social network.

28. The system of claim 26 wherein the operations further comprise:
suggesting one or more fourth individuals to the member of the first social network as potential participants for future events, wherein the one or more fourth individuals has interacted with the member within a preceding predetermined period of time.

29. The system of claim 28 wherein the member of the first social network and the one or more fourth individuals interacted via at least one of the first social network, a social network that is different than the first social network, Short Message Service (SMS) messaging, and e-mail.

30. The system of claim 28 wherein the operations further comprise:
presenting a view of graphical representations of potential participants for future events in a graphical user interface, wherein the view comprises a concatenation of graphical representations of the first individuals, the second individuals, the third individuals, and the fourth individuals.

31. A computer-readable storage medium having instructions stored thereon that when executed by data processing apparatus cause the data processing apparatus to perform operations comprising:
receiving acceptance from one or more first individuals and one or more second individuals of an invitation to attend an event scheduled using a first social network wherein the one or more first individuals are members of the first social network and the one or more second individuals are not members of the first social network;
selecting one or more of the second individuals based on a first set of criteria; and
suggesting the selected one or more second individuals to a member of the first social network as potential participants for future events.

32. A computer-implemented method comprising:
receiving user selection of one or more individuals to invite to an event;
receiving additional user input regarding the event; and
sending invitations to the one or more selected individuals,
wherein the steps of receiving additional user input and sending invitations, combined, comprise no more than three user interactions with a client device.

33. The computer-implemented method of claim 32 wherein the received additional user input includes a location for the event.

34. The computer-implemented method of claim 32 wherein the received additional user input includes a confirmation of the one or more selected individuals.

35. The computer-implemented method of claim 32 wherein a particular user interaction with the client device includes the user touching a screen of the client device.

36. The computer-implemented method of claim 32 wherein a particular user interaction with the client device includes the user engaging an input device operatively connected to the client device.

37. A system comprising:
one or more data processing apparatus programmed to perform operations comprising:
receiving user selection of one or more individuals to invite to an event;
receiving additional user input regarding the event; and
sending invitations to the one or more selected individuals,
wherein the steps of receiving additional user input and sending invitations, combined, comprise no more than three user interactions with a client device.

38. The system of claim 37 wherein the received additional user input includes a location for the event.

39. The system of claim 37 wherein the received additional user input includes a confirmation of the one or more selected individuals.

40. The system of claim 37 wherein a particular user interaction with the client device includes the user touching a screen of the client device.

41. The system of claim 37 wherein a particular user interaction with the client device includes the user engaging an input device operatively connected to the client device.

42. A computer-readable storage medium having instructions stored thereon that when executed by data processing apparatus cause the data processing apparatus to perform operations comprising:
receiving user selection of one or more individuals to invite to an event;
receiving additional user input regarding the event; and
sending invitations to the one or more selected individuals,
wherein the steps of receiving additional user input and sending invitations, combined, comprise no more than three user interactions with a client device.
